(19) United States
(12) Patent Application Publication
(10) Pub. No.: US 2014/0165125 A1
(43) Pub. Date: Jun. 12, 2014

(54) BROADCASTING SYSTEM AND BROADCASTING METHOD OF PROVIDING MULTI-PICTURE

(71) Applicant: Electronics and Telecommunications Research Institute, Daejeon (KR)

(72) Inventors: Gwang Soon LEE, Daejeon (KR); Hyun LEE, Daejeon (KR); Won Sik CHEONG, Daejeon (KR); Nam Ho HUR, Daejeon (KR)

(73) Assignee: Electronics and Telecommunications Research Institute, Daejeon (KR)

(21) Appl. No.: 14/103,169

(22) Filed: Dec. 11, 2013

(30) Foreign Application Priority Data
Dec. 11, 2012 (KR) 10-2012-0143761
Nov. 27, 2013 (KR) 10-2013-0145201

(51) Int. Cl. H04N 21/2365; H04N 21/2389; H04N 13/00

(52) U.S. Cl. CPC H04N 21/2365; H04N 13/0059; H04N 21/2389
USPC 725/118

(57) ABSTRACT

A broadcasting transmitting apparatus of providing a multi-picture may include a multi-picture generator configured to divide an acquired video into a first video and a second video; a first video encoder configured to encode the first video; a second video encoder configured to encode the second video; a multiplexer configured to multiplex the first and second videos to a single stream video; and a transmitter configured to modulate the multiplexed single stream video to transmit the modulated single stream video to a receiving apparatus through a broadcasting network.

This application claims the benefit of priority of Korean Patent Application No. 10-2012-0143761 filed on Dec. 11, 2012, and Korean Patent Application No. 10-2013-0145201 filed on Nov. 27, 2013, which are incorporated by reference as if fully set forth.

### BACKGROUND OF THE INVENTION

1. Field of the Invention

The present invention relates to a wireless communication, and more particularly, to a broadcasting system and a broadcasting method of providing a multi-picture.

2. Discussion of the Related Art

With development of a digital broadcasting technology, a video codec with improved compression efficiency has been developed, and an attempt to provide a video having high definition and quality close to a reality such as a 3D video on a large screen by using the developed video codec has lasted. In the advanced television system committee (ATSC) which is U.S and Korean digital broadcasting standard in the related art, a moving picture experts group-2 (MPEG-2) video codec is basically used, and resolution of the picture is maintained at a maximum size of 1920×1080 pixels.

Recently, in order to support a 3DTV broadcasting which is compatible with an existing digital broadcasting by applying the video codec, a 3DTV broadcasting technology adopting MPEG-4 AVC (advanced video coding) having compression efficiency up to about twice higher than the MPEG-2 video codec has been developed and standardized. In order to maintain compatibility with the existing digital broadcasting, the 3DTV broadcasting is multiplexed and transmitted by a single stream by compressing a left video to a MPEG-2 video and compressing a right video through the MPEG-4 AVC. In a receiver, an existing DTV receiver secures backward compatibility by decoding only the MPEG-2 video, and a 3DTV receiver acquires left and right videos by simultaneously decoding the MPEG-2 video and the MPEG-4 AVC to reproduce a 3D video through the acquired left and right videos.

With continuous development of the video codec technology, currently, a high efficiency video coding (HEVC) standard has been developed, and aimed to improve compression efficiency about maximum twice higher than the MPEG-4 AVC.

Meanwhile, an ultra-high definition TV (UHDTV) supports twice or more higher resolution (horizontal: 1,920×2 pixels, vertical: 1,080×2 pixels) in horizontal and vertical directions than an existing HDTV. However, in terms of a frequency, it is technically difficult to compress and transmit a video for the UHDTV at a current terrestrial broadcasting bandwidth, and as a result, it is expected that some time for a full-scale service is required. Accordingly, technologies to utilize a large-screen TV such as a multi-vision or an UHDTV while utilizing a 3DTV broadcasting technology which is compatible with an existing service and a high-efficiency video codec technology such as an HEVC and maintaining compatibility with an existing digital broadcasting service have been required.

### SUMMARY OF THE INVENTION

An object of the present invention is to provide a broadcasting system of providing a multi-picture and a service providing method.

Another object of the present invention is to provide a broadcasting system and a service providing method capable of utilizing a large-screen TV while maintaining compatibility with an existing digital broadcasting service.

Yet another object of the present invention is to provide a broadcasting system and a service providing method capable of being compatible with a DTV, a 3DTV, a multi-picture TV, and an UHDTV.

In accordance with an embodiment of the present invention, there is provided a broadcasting transmitting apparatus of providing a multi-picture. The broadcasting transmitting apparatus of providing a multi-picture may include a multi-picture generator configured to divide an acquired video into a first video and a second video; a first video encoder configured to encode the first video; a second video encoder configured to encode the second video; a multiplexer configured to multiplex the encoded first and second videos to a single stream video; and a transmitter configured to modulate the multiplexed single stream video to transmit the modulated single stream video to a receiving apparatus through a broadcasting network.

The second video may be constituted by two or more pictures, and the second video encoder may include two or more encoders.

The acquired video may include a stereoscopic 3D video constituted by a left side and a right side, the first video may include the left side of the 3D video, and the second video may include the right side of the 3D video.

The second video may be a video having higher resolution than the first video.

In accordance with another embodiment of the present invention, there is provided a broadcasting receiving apparatus of receiving a multi-picture. The broadcasting receiving apparatus may include a receiver configured to receive a plurality of videos multiplexed to a single stream video; demultiplexer configured to divide the received single stream video into first and second videos; a first video decoder configured to decode the first video; a second video decoder configured to decode the second video; and a multi-picture configuration unit configuring a picture based on the first and second decoded videos.

The second video may be constituted by two or more pictures, and the second video decoder may include two or more decoders.

The first video may include a left side of a stereoscopic 3D video constituted by the left side and a right side, and the second video may include the right side of the 3D video.

The second video may be a video having higher resolution than the first video.

The multi-picture configuration unit may horizontally connect the first video and the second video to configure the picture.

The multi-picture configuration unit may synthesize the left side and the right side of the 3D video to configure the picture.

In accordance with yet another embodiment of the present invention, there is provided a broadcasting transmitting method of providing a multi-picture. The broadcasting transmitting method may include dividing an acquired video into a first video and a second video; encoding the divided first video and second video, respectively; multiplexing the encoded first and second videos to a single stream video; and modulating the multiplexed single stream video to transmit the modulated single stream video to a receiving apparatus through a broadcasting network.

The second video may be constituted by two or more pictures, and the second video may be encoded by two or more encoders.

The acquired video may include a stereoscopic 3D video constituted by a left side and a right side, the first video may include the left side of the 3D video, and the second video may include the right side of the 3D video.

The second video may be a video having higher resolution than the first video.

In accordance with yet another embodiment of the present invention, there is provided a broadcasting receiving method of receiving a multi-picture. The broadcasting receiving method may include receiving a plurality of videos multiplexed to a single stream video; dividing the received single stream video into first and second videos; decoding the first video and the second video; and configuring a picture based on the decoded first and second videos.

The second video may be constituted by two or more pictures, and the second video may be decoded by two or more decoders.

The first video may include a left side of a stereoscopic 3D video constituted by the left side and a right side, and the second video may include the right side of the 3D video.

The second video may be a video having higher resolution than the first video.

The picture may be configured by horizontally connecting the first video and the second video.

The picture may be configured by synthesizing the left side and the right side of the 3D video.

According to the embodiments of the present invention, it is possible to provide a multi-picture TV broadcasting such as a panorama, by applying a high-efficiency video codec while maintaining compatibility with an existing digital broadcasting service. Further, it is possible to simultaneously provide various multimedia contents by using the UHDTV in a home to receive and broadcast a multi-picture video, even though UHDTV contents are not broadcasted through a terrestrial broadcasting.

### BRIEF DESCRIPTION OF THE DRAWINGS

FIG. 1 is a block diagram illustrating a broadcasting system of providing a multi-picture according to an embodiment of the present invention.

FIG. 2 is a flowchart illustrating an operation order of a broadcasting transmitting apparatus according to the embodiment of the present invention.

FIG. 3 is a flowchart illustrating an operation order of a high-definition video receiving apparatus according to the embodiment of the present invention.

FIG. 4 is an example of a method of providing a broadcasting service according to an embodiment of the present invention.

FIG. 5 is an example of a method of providing a broadcasting service according to another embodiment of the present invention.

FIG. 6 is an example of a method of providing a broadcasting service according to yet another embodiment of the present invention.

### DETAILED DESCRIPTION OF THE EMBODIMENTS

The present invention will be described more fully hereinafter with reference to the accompanying drawings, in which embodiments of the invention are shown. However, the present invention can be realized in various different forms, and is not limited to the exemplary embodiments described herein. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising”, will be understood to imply the inclusion of stated elements but not the exclusion of any other elements. In addition, the terms “-unit” described in the specification mean units for processing at least one function and operation and can be implemented by hardware components or software components and combinations thereof.

Hereinafter, embodiments of the present invention are described with reference to the accompanying drawings.

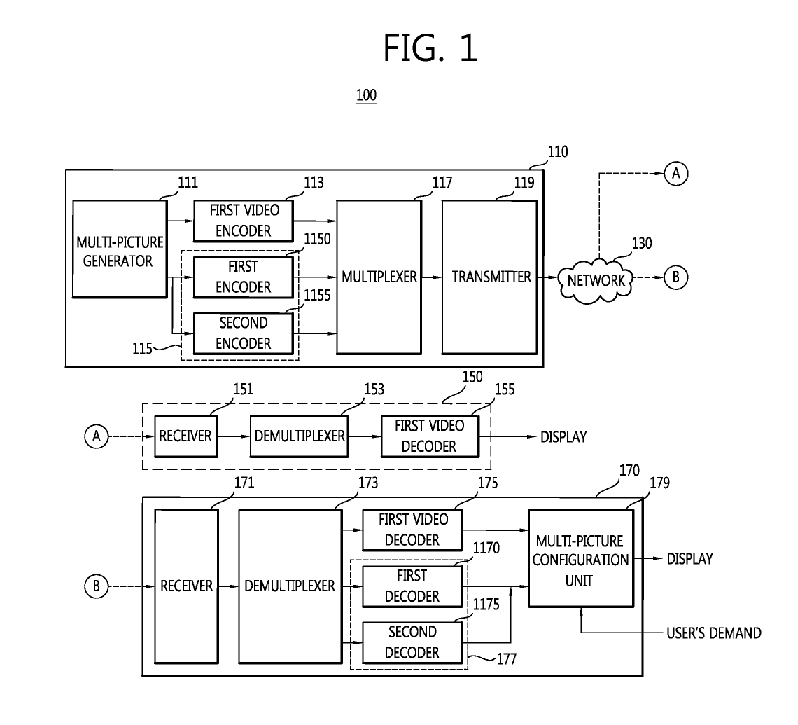

FIG. 1 is a block diagram illustrating a broadcasting system of providing a multi-picture according to an embodiment of the present invention.

Referring to FIG. 1, a broadcasting system 100 according to the embodiment includes a broadcasting transmitting apparatus 110, a transmission network 130, a DTV receiving apparatus 150, and a multi-picture receiving apparatus 170. The broadcasting transmitting apparatus 110 includes a multi-picture generator 111, a first video encoder 113, a second video encoder 115, a multiplexer 117, and a transmitter 119. The multi-picture generator 111 photographs a real video by using a panorama camera, a 3D camera, or the like or acquires the video through a computer graph, and then divides the acquired video into a first video and a second video. The multi-picture generator 111 acquires two or more videos which are not associated with each other to divide the acquired video into the first video and the second video. The acquired video may be twice or more larger in a field of view (FOV) than an existing DTV in horizontal and vertical directions. The multi-picture generator 111 may divide the acquired video into the first video and the second video through video distortion correction and preprocessing processes. The first video may be constituted by one picture, and the second video may be constituted by one or more pictures. The pictures configuring the second video may be a panorama video having a wide FOV. Further, the picture configuring the second video may be a picture having twice or more higher resolution (horizontal: 1,920×2 pixels, vertical: 1,080×2 pixels) in horizontal and vertical directions than an existing HDTV. The second video encoder 115 may include two encoders constituted by a first encoder 1150 and a second encoder 1155. When the second video encoder 115 includes one encoder, two or more multi-pictures horizontally connected to each other may be encoded by one encoder. Meanwhile, when the second video encoder 115 includes two encoders, the multi-pictures are divided into two pictures to be encoded by one encoder.

The multi-picture generator 111 divides the first video and the second video according to resolution to transmit a picture video having relatively low resolution to the first video encoder 115 and transmit a picture video having relatively high resolution to the second video encoder 117. For example, as the first video encoder 115, an encoder of an exiting digital broadcasting system such as an MPEG-2 video encoder may be used, and as the second video encoder 117, a latest high-efficiency codec encoder such as a high efficiency video coding (HEVC) may be used.

The multiplexer 117 multiplexes the first and second encoded videos to a single stream video, and the transmitter 119 transmits the multiplexed video to the broadcasting receiving apparatuses through the transmission network 130.

A receiver 151 of the DTV receiving apparatus 150 receives the video transmitted from the transmission network 130, and a demultiplexer 153 divides the multiplexed video from the received video to the single stream to transmit the divided multiplexed video to a first video decoder 155. The first video decoder 155 decodes only the first video of the divided videos to reproduce the first decoded video on a display.

The multi-picture receiving apparatus 170 includes a receiver 171, a demultiplexer 173, a first video decoder 175, a second video decoder 177, and a multi-picture configuration unit 179. The receiver 171 receives the video from the transmission network 130 to transmit the received video to the demultiplexer 173. The demultiplexer 173 divides the picture of the multiplexed video into the single stream to transmit the divided picture to the first video decoder 175 and the second video decoder 177. Among the divided pictures, according to resolution, the picture having relative low resolution may be transmitted to the first video decoder, and the picture having relatively high resolution may be transmitted to the second video decoder 177. Meanwhile, two or more pictures connected to each other in a horizontal direction may be transmitted to the second video decoder 177.

The first video decoder 175 and the second video decoder 177 decode the received videos, respectively. The first video decoder 175 may decode the video of the existing digital broadcasting such as an existing MPEG-2 video. The second video decoder 177 may include two decoders constituted by a first decoder 1770 and a second decoder 1175. When the second video decoder 177 includes two decoders 1170 and 1175, two or more multi-pictures are divided to be decoded by two decoders. Further, when the second video decoder 177 is constituted by one decoder, two or more multi-pictures horizontally connected to each other may be decoded by only the second decoder 1170. As the decoders 1170 and 1175 configuring the second video decoder, a high efficiency video coding (HEVC) decoder may also be used.

The multi-picture configuration unit 179 re-configures two or more pictures decoded through the first video decoder 175 and the second video decoder 177 to generate a multi-picture in which stereoscopic 3D videos constituted by left and right sides or two or more videos are horizontally connected to each other and reproduce the multi-picture on a display. Further, the multi-picture configuration unit 179 selectively receives a video form to be actually reproduced on the display by a user to reproduce the picture on the display according to a demand of the user.

In FIG. 1, the broadcasting system 100 includes one broadcasting transmitting apparatus 110, one DTV receiving apparatus, and one multi-picture receiving apparatus 170, respectively, but may include a plurality of apparatuses, respectively.

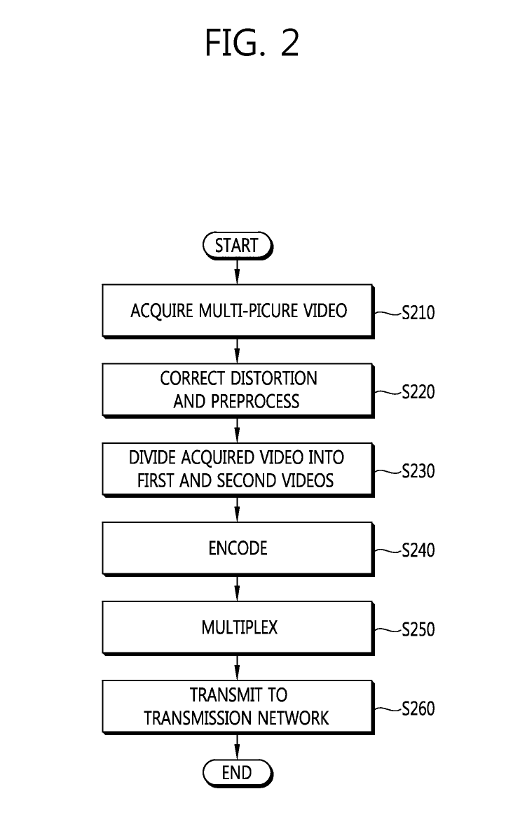

FIG. 2 is a flowchart illustrating an operation order of a broadcasting transmitting apparatus according to the embodiment of the present invention.

Referring to FIG. 2, the broadcasting transmitting apparatus 110 according to the embodiment of the present invention acquires a multi-picture video by the multi-picture generator 111 (S210). The multi-picture video may photograph a real video from a panorama camera or a 3D camera or acquire the video through a computer graphic. The acquired video may be twice or more larger in a field of view (FOV) in horizontal and vertical directions than an existing DTV.

When the video is acquired, the multi-picture generator 111 corrects distortion of the acquired video and performs pre-processing (S220), and then divides the corrected and pre-processed video into first and second videos (S230). The first video may be constituted by one picture, and the second video may be constituted by one or more pictures. The two or more pictures may be a panorama picture having a wide FOV. Further, the picture configuring the second video may support twice or more higher resolution (horizontal: 1,920×2 pixels, vertical: 1,080×2 pixels) in horizontal and vertical directions than an existing HDTV.

When the video is divided, the divided first video and second video are encoded by the first video encoder and the second video encoder (S240). The first video may be encoded to a video of an existing digital broadcasting such as a MPEG-2 video. The second video may be encoded by one or more high-definition video encoders. When the divided second video is two or more divided pictures, the divided second video may be compressed by two encoders. Further, in the case where the second video divided by the multi-picture generator 111 is the horizontally connected multi-pictures or one picture, the second video may be encoded by one encoder. In the encoding of the second video, a high-definition video encoder such as a high efficiency video coding (HEVC) encoder may be used.

The first and second encoded videos are multiplexed to the single stream video in the multiplexer 117, and the multiplexed video is transmitted from the transmitter 119 to the transmission network 130 (S260) to be distributed so that the broadcasting receiving apparatuses may receive the videos.

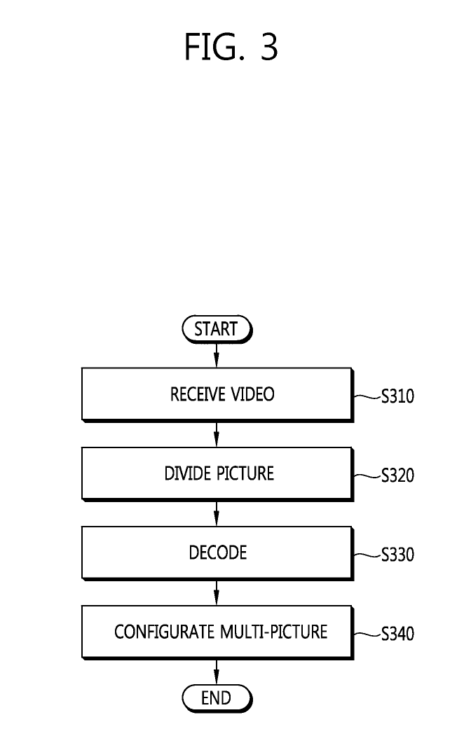

FIG. 3 is a flowchart illustrating an operation order of a high-definition video receiving apparatus according to the embodiment of the present invention.

First, the receiver 171 receives the video to transmit the received video to the demultiplexer 173 (S310). The demultiplexer 173 divides the picture of the received video into a first video and a second video to transmit the divided first and second videos to the first video decoder and the second video decoder (S320). Among the divided pictures, according to resolution, the picture having relatively low resolution may be transmitted to the first video decoder 175, and the picture having relatively high resolution may be transmitted to the second video decoder 177.

The first video decoder and the second video decoder decode the first video and the second video, respectively (S330). The first video decoder may decode the video of the existing digital broadcasting such as an existing MPEG-2 video. The second video decoder may include one or two or more decoders. In the case where the second video decoder includes two or more decoders, two or more divided multi-pictures may be decoded by respective decoders. As the high-definition video decoder, a high efficiency video coding (HEVC) decoder may be used.

When the first and second videos are decoded, the multi-picture configuration unit 179 configures the two or more decoded pictures to a stereoscopic 3D video constituted by a left side and a right side, two or more multi-pictures, or one high-definition picture to reproduce the configured pictures on the display (S340). The configuration of the picture is received by the user, and the picture configured by the user may be transmitted to the display.

Hereinafter, various embodiments of a method of configuring a multi-picture according to the present invention will be described with reference to the accompanying drawings.

### First Embodiment

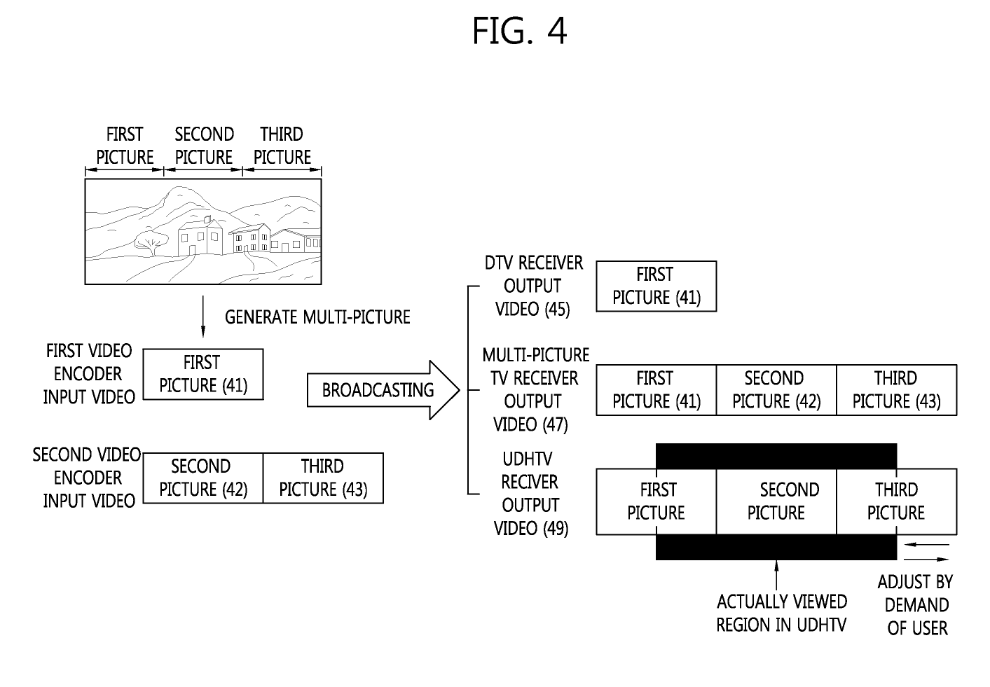

FIG. 4 illustrates a method of configuring a multi-picture according to an embodiment of the present invention.

Referring to FIG. 4, the multi-picture generator 111 may acquire a video having three times width based on an existing DTV picture through a camera or a computer graphic. The picture of the video is divided into three equal parts, and a first picture 41 is transmitted to a first video encoder 113, and second and third pictures 42 and 43 are transmitted to first and second decoders 1150 and 1155 of a second video encoder 115. The first picture 41 is encoded through the first video encoder 113, and the second picture 42 and the third picture 43 are encoded through the first and second encoders 1150 and 1155. The first video encoder 113 may use an MPEG-2 encoder in order to secure backward compatibility with an existing DTV. The encoded video is transmitted to the transmission network 130 through the multiplexer 117 and the transmitter 119.

In the case where a receiving apparatus is a single-picture receiving apparatus 45 such as an existing DTV, when the video is received from the receiver 151, the demultiplexer 153 divides the multiplexed video to a single stream to transmit the divided single stream to the first video decoder 155. The first video decoder 155 decodes only the first video of the divided videos to reproduce the first decoded video on a display.

In the case where the receiving apparatus is the receiving apparatus 170 having higher resolution than the existing DTV, such as a multi-picture TV receiver 47 or a UHDTV receiver 49, the demultiplexer 173 divides the video received from the receiver 171 into first to third pictures 41, 42, and 43. The first to third divided pictures 41, 42, and 43 are transmitted and decoded to the first video decoder 175, and the first decoder 1770 and the second decoder 1775 of the second video decoder 117, respectively, and transmitted to the multi-picture configuration unit 179. The multi-picture configuration unit 179 connects the first to third pictures 41, 42, and 43 decoded through the first video decoder 175, the first decoder 1770, and the second decoder 1775 in a horizontal direction. When the receiving apparatus is a multi-picture TV receiver 47 having three times higher resolution than the DTV in a horizontal direction, the first to third pictures 41, 42, and 43 sequentially connected to each other in the horizontal direction may be displayed. In the case where the receiving apparatus is the UHDTV receiver 49 having twice higher resolution in both horizontal and vertical directions than the DTV, the user directly selects a desired region on the first to third pictures 41, 42, and 43 sequentially connected to each other in the horizontal direction to control the region by a remote controller and the like. In the UHDTV receiver 49, an empty space in which an actual video is not output at the top and bottom of the screen, and the space may be used to reproduce other multimedia video contents received through a storage apparatus or an Internet network.

### Second Embodiment

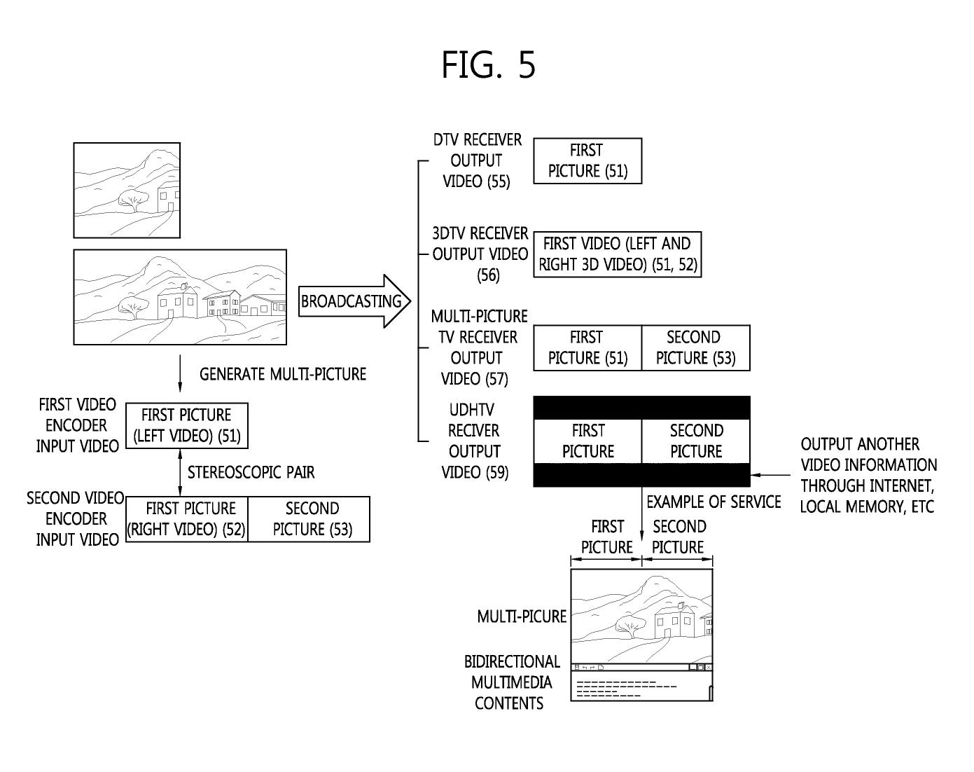

FIG. 5 illustrates a method of configuring a multi-picture according to another embodiment of the present invention.

Referring to FIG. 5, the multi-picture generator 111 may acquire stereoscopic 3D pictures 51 and 52 constituted by a left side and a right side and a video constituted by a second picture 53 through a camera or a computer graphic. The left side 51 of the first picture is transmitted to a general video encoder 113, and the right side 52 of the first picture is transmitted to a first high-definition video encoder 115. The remaining second picture 53 is transmitted to a second high-definition video encoder 116. The respective pictures are encoded by the encoders, and the encoded videos are transmitted to the transmission network 130 through the multiplexer 117 and the transmitter 119.

In the case where a receiving apparatus is a general video receiving apparatus 55 such as an existing DTV, when the video is received from the receiver 151, the demultiplexer 153 divides the multiplexed video to a single stream to transmit the divided single stream to the first video decoder 155. The first video decoder 155 decodes the left side 51 of the first video of the divided videos to reproduce the decoded left side 51. The first video decoder 155 may decode the right side 52 of the first picture instead of decoding the left side 51 of the first picture. Further, in the case where the video of the second picture is a video having decodable quality, the video of the second picture 53 may be decoded (not illustrated).

In the case where the receiving apparatus is a 3DTV receiver 56, when the receiver 171 receives the video, the received video is divided into the left side 51 of the first picture, the right side 52 of the first picture, and the second picture 53 in the demultiplexer 173 to be transmitted to the decoder. The left side 51 of the first picture is transmitted to the first video decoder 175, and the right side 52 of the first picture and the second picture 53 are transmitted to the second video decoder 177. The second video decoder 177 may decode only a part of the picture. Accordingly, even though the right side 52 of the first picture and the second picture 53 are transmitted to one decoder, only the right side 52 of the first picture may be divided and decoded. Further, when the second video decoder 177 includes two decoders of a first decoder 1770 and a second decoder 1175, the right side 52 of the first picture may be decoded by the first decoder 1770, and the second picture 53 may be decoded by the second decoder 1775.

The decoded left side 51 and right side 52 of the first picture are configured to 3D videos having a 3D effect by the multi-picture configuration unit 179 to be reproduced on the display.

In the case where the receiving apparatus is the receiving apparatus 170 having higher resolution than the existing DTV, such as a multi-picture TV receiver 57 or a UHDTV receiver 59, the demultiplexer 173 divides the video received from the receiver 171 into the left side 51 of the first picture, the right side 52 of the first picture, and the second picture 53. The left side 51 of the first picture is transmitted to the first video decoder 175, and the right side 52 of the first picture and the second picture 53 are transmitted to the second video decoder 177 to be decoded. The second video decoder 177 may decode only a part of the picture. Accordingly, even though the right side 52 of the first picture and the second picture 53 are transmitted to one decoder, only the second picture 53 may be divided and decoded. Further, when the second video decoder 177 is constituted by the first decoder 1770 and the second decoder 1175, the right side 52 of the first picture may be decoded by the first decoder 1770, and the second picture 53 may be decoded by the second decoder 1775.

The decoded videos of the left side 51 of the first picture and the second picture 53 are connected to each other in a horizontal direction in the multi-picture configuration unit 179 to be displayed. In the UHDTV receiver 59, an empty space in which an actual video is not output at the top and bottom of the screen, and the space may be used to reproduce other multimedia video contents received through a storage apparatus or an Internet network.

### Third Embodiment

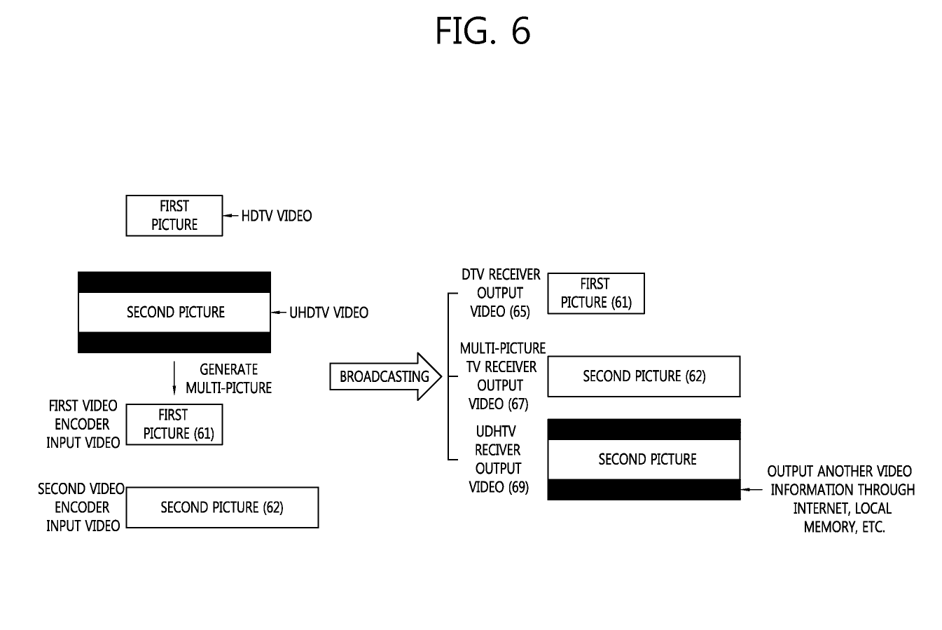

FIG. 6 is an example of configuring a multi-picture according to yet another embodiment of the present invention.

Referring to FIG. 6, the multi-picture generator 111 may acquire a first picture 61 and a second picture 62 which are not associated with each other. The first picture 61 may be constituted by an HDTV video, and the second picture 62 may be constituted by a UHDTV picture. The first and second pictures 61 and 62 may be acquired through a camera or a computer graphic. The second picture 62 may be a video having a size of ½ of the UHDTV video in a vertical direction. For example, the second picture 62 may have resolution of 1,920×2 pixels in a horizontal direction and resolution of 1,080 pixels in a vertical direction. As such, the reason of having the size of ½ of the UHDTV video in the vertical direction is to overcome a shortage of a channel capacity of the terrestrial broadcasting, and when a limit of the transmission capacity is overcome, the second picture 62 may have a size of the entire UHDTV picture even in the vertical direction.

The first picture 61 is transmitted to the first video encoder 113, and the second picture 62 is transmitted to the second video encoder 115. The respective pictures transmitted to the encoders are encoded by the encoders to be transmitted to the transmission network 130 through the multiplexer 117 and the transmitter 119.

In the case where the receiving apparatus is the DTV receiver 65, when the video is received from the receiver 151, the multiplexed video is divided into the first picture 61 and the second picture 62 in the demultiplexer 153 to be transmitted to the first video decoder 155. The first video decoder 155 decodes only the first picture 61 of the divided videos to reproduce the first picture 61.

In the case where the receiving apparatus is the receiving apparatus 170 having higher resolution than the existing DTV, such as a multi-picture TV receiver 67 or a UHDTV receiver 69, the video received from the receiver 171 is divided into the first picture 61 and the second picture 62 in the demultiplexer 173 to be transmitted to the second video decoder 177. The second video decoder 177 may decode only a part of the picture. Accordingly, even though the first picture 61 and the second picture 62 are transmitted to one decoder, only the second picture 62 may be divided and decoded. The video of the second decoded picture 62 is displayed through the multi-picture configuration unit 179. In the UHDTV receiver 69, an empty space in which an actual video is not output at the top and bottom of the screen, and the space may be used to reproduce other multimedia video contents received through a storage apparatus or an Internet network.

The above description is illustrative purpose only and various modifications and transformations become apparent to those skilled in the art within a scope of an essential characteristic of the present invention. Accordingly, the various embodiments disclosed herein are not intended to limit the technical spirit but describe with the true scope and spirit being indicated by the following claims. The scope of the present invention may be interpreted by the appended claims and the technical spirit in the equivalent range is intended to be embraced by the invention.

What is claimed is:

1. A broadcasting transmitting apparatus of providing a multi-picture, comprising:
a multi-picture generator configured to divide an acquired video into a first video and a second video;
a first video encoder configured to encode the first video;
a second video encoder configured to encode the second video;
a multiplexer configured to multiplex the encoded first and second videos to a single stream video; and
a transmitter configured to modulate the multiplexed single stream video to transmit the modulated single stream video to a receiving apparatus through a broadcasting network.

2. The broadcasting transmitting apparatus of claim 1, wherein the second video is constituted by two or more pictures, and the second video encoder includes two or more encoders.

3. The broadcasting transmitting apparatus of claim 1, wherein the acquired video includes a stereoscopic 3D video constituted by a left side and a right side, the first video includes the left side of the 3D video, and the second video includes the right side of the 3D video.

4. The broadcasting transmitting apparatus of claim 1, wherein the second video is a video having higher resolution than the first video.

5. A broadcasting receiving apparatus of receiving a multi-picture, comprising:
a receiver configured to receive a plurality of videos multiplexed to a single stream video;
demultiplexer configured to divide the received single stream video into first and second videos;
a first video decoder configured to decode the first video;
a second video decoder configured to decode the second video; and
a multi-picture configuration unit configuring a picture based on the decoded first and second videos.

6. The broadcasting receiving apparatus of claim 5, wherein the second video is constituted by two or more pictures, and the second video decoder includes two or more decoders.

7. The broadcasting receiving apparatus of claim 5, wherein:
the first video includes a left side of a stereoscopic 3D video constituted by the left side and a right side, and
the second video includes the right side of the 3D video.

8. The broadcasting receiving apparatus of claim 5, wherein the second video is a video having higher resolution than the first video.

9. The broadcasting receiving apparatus of claim 5, wherein the multi-picture configuration unit horizontally connects the first video and the second video to configure the picture.

10. The broadcasting receiving apparatus of claim 7, wherein the multi-picture configuration unit synthesizes the left side and the right side of the 3D video to configure the picture.

11. A broadcasting transmitting method of providing a multi-picture, comprising:
dividing an acquired video into a first video and a second video;
encoding the divided first video and second video, respectively;
multiplexing the encoded first and second videos to a single stream video; and
modulating the multiplexed single stream video to transmit the modulated single stream video to a receiving apparatus through a broadcasting network.

12. The broadcasting transmitting method of claim 11, wherein the second video is constituted by two or more pictures, and the second video is encoded by two or more encoders.

13. The broadcasting transmitting method of claim 11, wherein the acquired video includes a stereoscopic 3D video constituted by a left side and a right side, the first video includes the left side of the 3D video, and the second video includes the right side of the 3D video.

14. The broadcasting transmitting method of claim 11, wherein
the second video is a video having higher resolution than the first video.
